(19) United States
(12) Patent Application Publication
(10) Pub. No.: US 2026/0129013 A1
(43) Pub. Date: May 7, 2026

(54) SUBSCRIPTION RESOURCE ENGINE(S) FOR SUPPRESSING TRANSMISSION OF NOTIFICATIONS TO ORIGINATING NETWORK FUNCTIONS

(71) Applicant: Oracle International Corporation, Redwood city, CA (US)

(72) Inventors: Rajiv Krishan, Cary, NC (US); Tukaram Maruti Khandekar, North Chelmsford, MA (US)

(21) Appl. No.: 18/934,402

(22) Filed: Nov. 1, 2024

(51) Int. Cl. H04L 51/212; H04W 8/18

(52) U.S. Cl. CPC H04L 51/212; H04W 8/18

(57) ABSTRACT

Various embodiments of the present technology generally relate to systems and methods for providing a subscription resource engine to suppress transmission of event notifications to originating network functions (NFs). For example, a subscription resource engine may detect an event operation associated with a consumer NF within a network. The consumer NF may be subscribed to a producer NF such that the subscription allows the consumer NF to receive event notifications from the producer NF. The subscription resource engine may determine that the event operation is related to the subscription and generate a subscription resource header based on the subscription. Based on the subscription resource header, the subscription resource engine may then generate an indication to suppress transmission of an event notification to the consumer NF. The indication to suppress transmission of the event notification may cause the producer NF to skip transmission of the event notification to the consumer NF.

### TECHNICAL FIELD

Various embodiments of the present technology generally relate to network function communication within networks. More specifically, embodiments of the present technology relate to systems and methods for providing a subscription resource engine for suppressing transmissions of notifications to originating network functions within a network.

### BACKGROUND

Communication networks, such as 4G and 5G, have become the backbone of modern communication, revolutionizing how people and devices connect across the globe. These technologies provide the essential infrastructure for high-speed, reliable wireless communication, enabling everything from everyday smartphone use to complex industrial applications. 4G networks laid the foundation by introducing fast data transfer rates and improved mobile internet experiences. Now, with the advent of 5G, the world is witnessing unprecedented advancements in speed, capacity, and low-latency communication, paving the way for transformative applications like autonomous vehicles, smart cities, and the Internet of Things (IoT). These networks collectively form the cornerstone of modern communication, driving innovation and shaping the future of global connectivity.

Within communication networks, such as 4G and 5G, network functions often subscribe to each other to ensure efficient and coordinated service delivery. A subscription in this context involves one network function registering its interest in receiving specific data or events from another network function. For example, a user authentication function might subscribe to notifications from a location service to track user mobility across different network cells. Subscriptions typically include details such as the type of data or events requested, conditions for triggering notifications, and the duration of the subscription. This dynamic interaction allows network functions to communicate seamlessly, facilitating tasks such as load balancing, service orchestration, and policy enforcement. These interdependencies are key to ensuring the reliability, scalability, and adaptability of modern communication networks, particularly as they manage complex services like IoT devices and real-time multimedia applications.

One issue with conventional subscription frameworks within communication networks, such as a 5G network, is that the consumer network function (NF) that subscribes to a producer NF is sometimes the very source of the change it is monitoring. For example, when a consumer NF initiates an operation like creating or deleting a resource, it may still receive a notification of this change from the producer NF, even though it originated the action. This redundant notification leads to inefficient processing and unnecessary signaling overhead, as the consumer NF is alerted to information it already possesses. In large-scale networks where multiple NFs interact, this can result in excessive signaling traffic, wasted computational resources, and degraded network performance, including slower response times and reduced capacity to handle other critical tasks.

Accordingly, there exists a need for systems and techniques for improved subscription frameworks within communication networks. In particular, there is a need for a subscription resource engine that monitors operational events within a subscription between a consumer NF and producer NF to identify scenarios when the triggering event is from a particular consumer NF. As will be described in greater detail below, when the subscription resource engine identifies a notification that is triggered by an originating consumer NF, the subscription resource engine may cause the producer NF to suppress transmission of the notification to the originating consumer NF.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing a subscription resource engine and one or more of its related functions. As described in greater detail below, the subscription resource engine may determine an event operation associated with a consumer NF within a network. In particular, the subscription resource engine may determine when an event operation is associated with a subscription between a consumer NF and a producer NF within a communication network. Under the subscription, the consumer NF may be a subscribed NF such to receive event notifications from the producer NF regarding specific resources or objects that are relevant to the consumer NF.

In some embodiments when an event operation is detected, a consumer-side subscription resource engine may generate a subscription resource header based on the subscription between the consumer NF and the producer NF. The subscription resource engine may coordinate with the consumer NF to include the subscription resource header in a communication to the producer NF. The communication may be provided to the provider NF to notify the producer NF of the event operation, and in some cases request the producer NF perform one or more actions based on the event operation.

Responsive to receiving the communication, the producer NF may accept or perform the requested change based on the event operation. Based on the communication, a producer-side subscription resource engine may determine that the consumer NF is the originating NF of the event operation. In particular, the producer-side subscription resource engine may parse the communication to identify the subscription resource header and identify the consumer NF as the originating NF based on the subscription resource header. Once the subscription resource engine determines that the consumer NF is the originating NF, the subscription resource engine may generate an indication that the producer NF should suppress transmission of an event notification to the consumer NF. As the producer NF transmits the event notifications to subscribed NFs under the subscription, the producer NF may skip transmission of the event notification to the consumer NF based on the indication generated by the subscription resource engine.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a 5G network in which one or more features of a subscription resource engine can be implemented, according to an embodiment herein;

FIG. 2 illustrates an example operational flow in which a consumer NF subscribes to a producer NF, according to an embodiment herein;

FIG. 3 illustrates an operational environment 300 including a subscription resource engine, according to an embodiment herein;

FIG. 4 provides an example subscription resource engine process, according to an embodiment herein;

FIG. 5 illustrates an example operational flow for providing one or more functions of a subscription resource engine, according to an embodiment herein;

FIG. 6 provides an example operational flow illustrating a subscription resource engine operating as part of a NF set, according to an embodiment herein;

FIG. 7 provides an example operational flow illustrating an embodiment in which a subscription resource engine refrains from suppressing transmission of an event notification to an originating NF, according to an embodiment herein; and

FIG. 8 shows an example computing device suitable for providing a subscription resource engine and its related functions, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Communication networks, such as 4G and 5G, have become the foundation of modern communication, fundamentally transforming how people and devices interact across the world. These technologies provide the necessary infrastructure for fast and reliable wireless connectivity, supporting everything from daily smartphone use to advanced industrial operations. While 4G laid the groundwork by delivering faster data speeds and enhancing mobile internet experiences, 5G has ushered in a new era of connectivity with remarkable improvements in speed, capacity, and low latency. This has enabled the development of cutting-edge applications like autonomous vehicles, smart cities, and the Internet of Things (IoT).

Within these networks, network functions frequently subscribe to each other to maintain efficient and coordinated service management. A subscription involves one network function expressing interest in receiving specific data or event notifications from another. For instance, a user authentication function may subscribe to a location service to monitor a user's movement across network cells. Such subscriptions generally define the type of data or events to be communicated, the conditions for triggering updates, and how long the subscription lasts. This interconnected communication allows network functions to perform critical tasks such as load balancing, service orchestration, and policy management. The interdependence of these functions is crucial for ensuring the performance, scalability, and adaptability of modern communication networks, especially as they handle increasingly complex services like IoT devices and real-time multimedia.

Under conventional subscription frameworks, when a network function (NF) detects an event operation, such as a create, delete, or update operation, it shares this information with the respective producer NF responsible for managing the related resource or service. For example, if a consumer NF performs a “create operation” to establish a new session, it informs the producer NF of this event. Upon receiving this notification, the producer NF may then propagate this information to any subscribed NFs that have expressed interest in updates related to such operations. For instance, if a session management function subscribes to the producer NF to monitor session changes, it will receive a notification about the newly created session. Similarly, if a “delete operation” occurs to remove a resource, the producer NF may notify other subscribed functions, like an analytics function tracking active session counts. This mechanism ensures that all relevant NFs are kept informed about operational changes in the network, enabling coordinated actions such as resource allocation, policy updates, or service adjustments.

The conventional subscription framework, however, can introduce inefficiencies into the network by generating redundant notifications, particularly when the subscribing NF is the originator of the initial event operation. For example, after performing an action like creating, deleting, or updating a resource, the subscribing NF may still receive a notification from the producer NF regarding the same event it initiated. This creates unnecessary signaling traffic, as the subscribing NF is already aware of the change it made. The result is not only redundant information flow but also additional processing overhead, which can strain network resources. This inefficiency becomes particularly problematic in large-scale networks, such as 5G, where multiple NFs interact continuously, potentially causing performance bottlenecks and reducing overall network efficiency.

To address at least these issues, an example subscription resource engine and its related functions are provided herein. As will be described in greater detail below, a subscription resource engine may improve upon the conventional subscription framework to suppress transmission of event notifications to the originating NF, thereby minimizing unnecessary signaling and ensuring smoother network operation. To suppress transmission of redundant notifications to an originating NF, the subscription resource engine may identify when an event notification generated under a subscription is triggered by an event operation from an originating NF that is also a subscribing NF within the subscription. When the subscription resource engine identifies that one of the subscribing NFs is the originating NF of the event operation resulting in the event notification, the subscription resource engine may communicate with the producer NF to suppress transmission of the event notification to the originating NF. Suppression of event notification transmission to an originating NF may occur even when event operation information is routed to the producer NF through intermediary NFs, such as Service Communication Proxy (SCP) and Security Edge Protection Proxy (SEPP).

By suppressing transmission of event notifications to an originating NF, the subscription resource engine reduces redundant or unnecessary notifications to the originating NF, thereby minimizing signaling bandwidth within the network and reducing the processing overhead for both the originating NF and the producer NF. That is, the subscription resource engine improves overall network efficiency by reducing unnecessary traffic, which in turn frees up bandwidth and processing power for more critical operations. This reduction in signaling allows the network to handle a higher volume of data and devices without being overwhelmed, which is particularly important in 5G networks that support dense connectivity and high-demand applications like the IoT and real-time multimedia. Additionally, by eliminating redundant notifications, the subscription resource engine lowers the processing loads of the NFs, leading to faster response times and more efficient resource utilization. Moreover, for IoT devices, battery-powered devices, and almost any device where reducing energy consumption is desirable, reducing unnecessary notifications can extend the battery life of the respective device, as less energy is consumed in handling extraneous signaling. Ultimately, by suppressing transmission of event notifications to an originating NF, the subscription resource engine contributes to improved scalability, better quality of service (QoS), and enhanced user experiences, as the network becomes more responsive and capable of handling future demands.

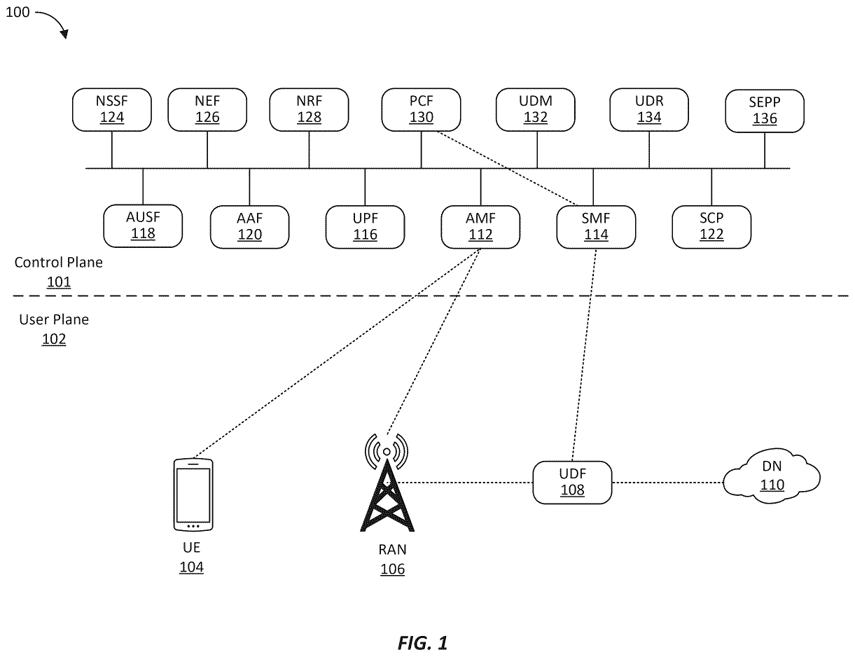

Turning now to the Figures, FIG. 1 illustrates an example operational environment for a 5G network 100 in which one or more features of a subscription resource engine can be implemented, according to an embodiment herein. The example 5G network 100 is a 5G core (5GC) cellular network implementing 3GPP (3rd Generation Partnership Project) communication standards, although the present disclosure may apply to other communication networks. It should be appreciated that while the following discussion focuses on a 5G network, the subscription resource engine may also operate within other communication networks. For example, the subscription resource engine may be employed within a 4G network that is enabled to use 5G resources.

The 5G network 100, its components, and their sub-components may be implemented via computers, servers, hardware and software modules, or other system components. The components of the 5G network 100 and its subcomponents, or the physical devices implementing them, may be co-located, remotely distributed, or any combination thereof. The elements of 5G network 100 may include components hosted or situated in the cloud and implemented as software modules potentially distributed across one or more server devices or other physical components.

The 5G network 100 is divided into two fundamental planes: a control plane 101 and a user plane 102, each serving distinct yet interdependent roles. The control plane 101 is responsible for managing the signaling and control information necessary to establish, modify, and terminate communication sessions. The control plane 101 handles tasks such as authentication, policy enforcement, and mobility management. As such, the control plane 101 is crucial for orchestrating and controlling the NFs, ensuring efficient and secure connectivity. On the other hand, the user plane 102 deals with the actual data transmission—the movement of user data between devices and applications. It is optimized for high-throughput, low-latency data delivery, and is designed to efficiently transport user traffic. The separation of the control plane 101 and user plane 102 in the 5G network 100 enhances scalability, flexibility, and enables network slicing, allowing tailored configurations to meet diverse service requirements. Together, these planes 101 and 102 form a cohesive architecture that empowers the 5G network 100 to deliver unprecedented speed, reliability, and versatility for a wide array of applications and services.

As noted above, the user plane 102 of the 5G network 100 operates in tandem with the control plane 101 to deliver efficient and seamless data transmission. For example, as illustrated, when a User Equipment (UE) 104, which could be a smartphone or any other device, initiates a communication the user plane 102 handles the actual user data traffic. When the UE 104 initiates communication, the Radio Access Network (RAN) 106 comes into play, managing the wireless connection between the UE 104 and the network 100, in particular the UE 104 and the Access and Mobility Management Function (AMF) 112. The RAN 106 acts as the bridge between the user plane 102 and the control plane 101, facilitating the establishment of communication sessions. As data travels through the RAN 106, it encounters the User Data Function (UDF) 108, which plays a pivotal role in processing and optimizing user data. The UDF 108 is responsible for tasks such as traffic optimization, content caching, and data transformation, enhancing the efficiency of data delivery.

The UDF 108 provides the data to the Data Network (DN) 110, which could represent the broader internet or a specific network service. The DN 110 processes and delivers the user data to its intended destination, completing the journey initiated by the UE 104. The collaborative operation of the user plane 102, UE 104, RAN 106, UDF 108, and DN 110 ensures that data is transmitted reliably and efficiently, meeting the high-performance expectations of 5G networks. As those skilled in the art readily appreciate, the separation of user plane 102 and control plane 101 allows for flexible network configurations and optimizations, contributing to the enhanced capabilities of the 5G ecosystem.

As noted above, when the UE 104 initiates a communication within the 5G network 100, the AMF 112 coordinates the interaction. For example, when the UE 104 initiates communication or moves within the 5G network 100, it sends signaling messages to the AMF 112. The AMF 112 is responsible for tasks such as authentication, authorization, and mobility management. Upon receiving the signaling messages from the UE 104, the AMF 112 validates the user's identity, checks for necessary permissions, and establishes the necessary context for the session. The AMF 112 coordinates with other network functions, such as the Session Management Function (SMF) 114 and the User Plane Function (UPF) 116, to ensure the seamless setup and management of communication sessions. The interaction with the control plane 101 enables the UE 104 to access network services, adhere to established policies, and maintain continuous connectivity while benefiting from the advanced capabilities and optimizations offered by the 5G network architecture.

The control plane 101 includes example components, nodes, or NFs. As illustrated, the control plane 101 includes the AMF 112, the SMF 114, the UPF 116, an Authentication Server Function (AUSF) 118, an Authentication and Authorization Function (AAF) 120, Service Communications Proxy (SCP) 122, a Network Slice Selection Function (NSSF) 124, Network Exposure Function (NEF) 126, a Network Repository Function or NF Repository Function (NRF) 128, a Packet Core Function (PCF) 130, a Unified Data Management (UDM) 132, Unified Data Repository (UDR) 134, and a Security Edge Protection Proxy (SEPP) 136. The selection of NFs 112-136 depicted in the 5G network 100 is exemplary, and some of the NFs 112-136 may be excluded, or other NFs added to the collection, without departing from the scope of this disclosure. The various NFs 112-136 execute various operations to provide communication services to UEs, such as the UE 104, that connects to the 5G network 100. A network node or NF that provides service is referred to herein as a Producer NF, while a network node or NF that consumes services is referred herein to as a Consumer NF. A network function can be both a Producer NF and a Consumer NF depending on whether it is consuming or providing service.

The NFs 112-136 of the 5G network 100 exchange various communications in the course of providing network services. The communications may include messaging to establish or end secured communication channels, such as transport layer security (TLS) handshakes, as well as service-based interface (SBI) communications. As used herein, SBI is the term given to the application programming interface (API) based communication that can take place between two NFs within the 5G SBA. A given NF can utilize an API call over the SBI to invoke a particular service or service operation. Communications between NFs 112-136 may be performed over network links and communication channels of the 5G network 100 that are not explicitly depicted in FIG. 1.

When the UE 104 initiates communication within the 5G network 100, various network functions often operate in pairs, where one NF acts as the producer (“the Producer NF”), generating or providing specific services or information, and the other NF acts as the consumer (the “Consumer NF”), utilizing or consuming the produced services or information to complete service requests. For instance, consider the interaction between the SMF 114 and the Packet Core Function (PCF) 130. The SMF 114, as the Consumer NF, initiates service requests related to session establishment, modification, or termination for UE sessions, such as for the UE 104. The SMF 114 communicates these requests to the PCF 130, acting as the Producer NF, which performs functions related to session management, Quality of Service (QoS) enforcement, and access control. The PCF 130 processes the requests from the SMF 114, enforces QoS policies, manages session establishment and modification, and ensures appropriate access control based on network policies and conditions. Through this producer-consumer interaction, the SMF 114 and PCF 130 collaborate to deliver efficient and reliable service within the 5G network architecture.

As those skilled in the art readily appreciate, various NFs may act as producer NFs and consumer NFs. For example, a producer NF may be or include the PCF 130, the SMF 114, the UDR 134, a charging function (CHF), Binding Support Function (BSF) (not shown) or a Network Data Analytic Function (NWDAF) (not shown). depending on the operation and the service request. A consumer NF may be or include the UE 104, a service capability function (SCF) (not shown), the SCP 122, the SMF 114, the PCF 130, the AMF 112, the NEF 126, a security edge protection proxy (SEPP) 136, the UDR 134, or a charging function (CHF), depending on the operation and the service request.

As noted above, the 5G network 100 includes the SEPP 136. The SEPP 136 plays a crucial role in enhancing the security framework of the 5G network 100. For example, the SEPP 136 may act as a gateway between the 5G core network 100 and external networks, such as a visitor network, or service providers, thereby ensuring that all data exchanges are secure and compliant with the latest security protocols. It protects against unauthorized access and potential threats by encrypting and decrypting signaling messages, thereby safeguarding the integrity and confidentiality of communications. By monitoring and filtering traffic at the network edge, the SEPP 136 also helps in detecting and mitigating various cyber threats, ensuring robust protection for the 5G network's 100 expansive and dynamic infrastructure.

The SEPP 136 also plays an integral role in the security architecture of the 5G network 100 by interacting with other network functions to validate access tokens, such as OAuth tokens, for roaming or visitor devices. When a visitor device roams into a new network, such as the 5G network 100, the SEPP 136 forwards the service request to the AAF 120 or similar network function responsible for token validation. The AAF 120 verifies the legitimacy and validity of the token, checking for factors like expiration and scope of access. Once the token is authenticated, the AAF 120 communicates the result back to the SEPP 136, which then ensures that only authorized devices gain access to the 5G network's 100 services. This collaborative process helps maintain stringent security standards and enables secure, seamless connectivity for roaming devices within the 5G network 100.

Within the 5G network 100, one or more consumer NFs may subscribe to a producer NF to ensure efficient data exchange and coordinated operations. In this context, a consumer NF, such as a PCF 130 or SMF 114, may request updates or notifications from a producer NF, like a UDR 134 or NRF 128. This subscription enables the consumer NF to stay informed about specific resources or objects managed by the producer NF, such as updates to session data, user policies, or network resource statuses. For instance, a consumer NF may subscribe to receive notifications regarding the availability of updated user-specific policies, allowing it to adjust its operational behavior in real-time. This subscription model plays a critical role in the dynamic interaction between NFs, supporting low-latency, high-efficiency communication in the 5G network, and ensuring that essential services are delivered seamlessly across the network's infrastructure.

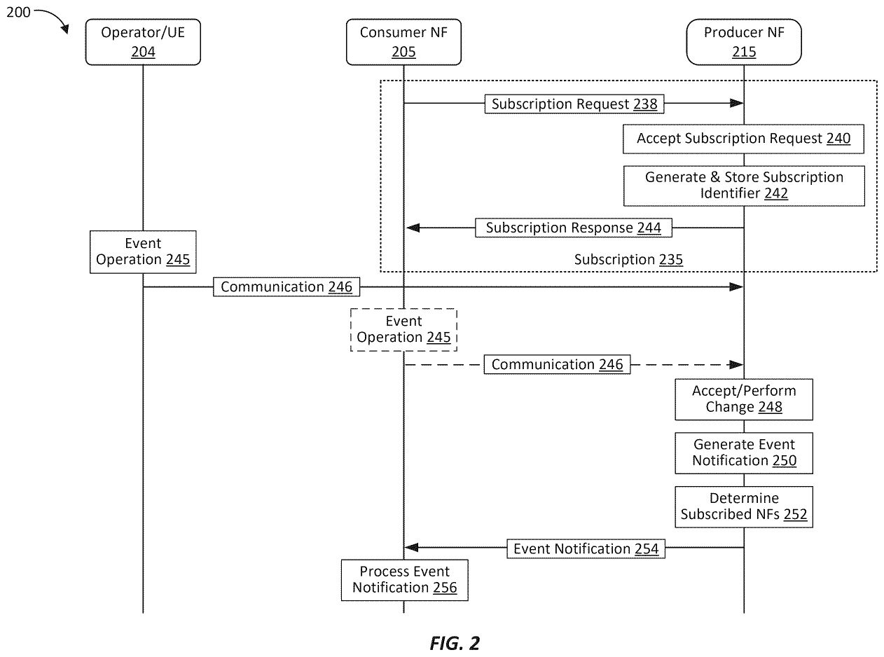

Referring now to FIG. 2, an example operational flow 200 in which a consumer NF 205 subscribes to a producer NF 215 is illustrated, according to an embodiment herein. For ease of illustration, FIG. 2 is described in the context of a 5G network environment, such as the 5G network 100, however, it should be appreciated that the following is equally applicable to other networks, such as a 4G network utilizing 5G network functions.

As illustrated, the consumer NF 205, which may be a PCF, may subscribe to the producer NF 215 (235), which may be a UDR, to receive certain notifications or data updates. To initiate the subscription, the consumer NF 205 sends a subscription request to the producer NF 215 (238). The subscription request may contain details of the event or data that the consumer NF 205 is interested in receiving from the producer NF 215. Upon receiving the subscription request, the producer NF 215 may validate the subscription request and, if accepted, proceed to register the subscription (240).

Responsive to accepting and registering the subscription, the producer NF 215 generates a unique subscription-Id (242), which it associates with the subscription for future reference. The producer NF 215 may store the subscription-Id internally to manage and track the subscription on its end. To allow the consumer NF to also manage the subscription, the producer NF 215 generates and sends a subscription identifier to the consumer NF 205. The subscription identifier may be or include a Uniform Resource Identifier (URI) provided to the consumer NF 205 within a “Location” header of a subscription response. The URI may serve as the subscription identifier and uniquely reference the subscription resource so that the consumer NF 205 can interact with the producer NF 215 to modify or cancel the subscription.

After generating and storing the subscription identifier, the producer NF 215 sends a subscription response back to the consumer NF 205 (244). As noted above, the subscription response confirms the successful subscription and typically includes the subscription identifier, allowing the consumer NF 205 to manage or modify the subscription in the future. Now that the subscription is established, the consumer NF 205 may receive notifications from the producer NF 215 based on the conditions specified in the subscription request. These notifications allow the consumer NF 205 to stay updated on relevant events or data changes, ensuring seamless interaction and real-time responsiveness between the two network functions.

In some cases, the consumer NF 205, such as the PCF 130, may subscribe to the producer NF 215 (e.g., UDR 134) on behalf of another network function, entity, or UE 204. For example, the consumer NF 205 may act on behalf of a SMF or NEF or even a User Equipment (UE) 204. In such scenarios, the consumer NF 205 includes information in the subscription request that identifies the third party, such as the SMF or UE 204, for which the subscription is being established. This allows the producer NF 215 to manage and track the subscription accordingly, ensuring that notifications or data updates are related to the specific operator or UE. The consumer NF 205 serves as an intermediary, ensuring that the relevant NF or UE 204 benefits from the subscription without having to directly interact with the producer NF 215, streamlining communication and coordination across the network.

Under the subscription, when an event operation, such as a create, delete, or update, occurs, it may trigger the producer NF 215 to notify the subscribed NFs of the changes made according to the specific criteria set in the subscription. As noted above, the subscription defines what types of events are relevant for the subscribed NF, here the consumer NF 205, such as updates to specific data objects. When the producer NF 215 detects an event operation that matches the subscription criteria, such as an update to a data object, it generates an event notification. This notification includes details such as the type of event, the affected resource, and any relevant data changes, ensuring the subscribing NFs are informed promptly of the changes.

As illustrated, an event operation may occur (245) at the consumer NF 205 or at an NF or UE 204 for which the consumer NF 205 has subscribed on behalf of. In response to the event operation, the respective party (e.g., operator/UE 204 or the consumer NF 205) may request that the producer NF 215 perform a change based on the event. To make such a request, the operator/UE 204 or the consumer NF 205, depending on the particular arrangement, may transmit a communication 246 to the producer NF 215. This communication 246 may include information regarding the event operation. Upon receiving the communication, the producer NF 215 may validate and accept the request, then proceed to perform the requested change (246).

In an illustrative example, the consumer NF 205 may be the PCF 130 that is subscribed to the UDR 134 (e.g., producer NF 215) to receive notifications about changes to OperatorSpecificData that are relevant to session management. In this scenario, the PCF 130 (e.g., consumer NF 205) specifies that it wants to be notified when there are changes in the operator-specific data, as these changes could impact how sessions are managed. If, during the operation of the network, the PCF 130 determines that an update to the OperatorSpecificData is needed (e.g., the event operation), it may send a request (e.g., the communication 246) to the UDR 134 (e.g., producer NF 215) to make the necessary changes. Upon receiving this request, the UDR 134 processes the update to the OperatorSpecificData as instructed by the PCF 130.

Under the subscription, once the producer NF 215 performs the requested change, it may generate an event notification (250) to inform any subscribed NFs of the update. To notify the appropriate subscribed NFs, the producer NF 215 first determines which NFs are subscribed under the respective subscription (252). This may be achieved by referencing its internal subscription records, where each subscription is associated with specific NFs and criteria for notifications. For example, the producer NF 115 may check the subscription database to identify NFs that have subscribed to receive notifications about the particular type of change that was made. Once the relevant NFs are identified, the producer NF 215 transmits the event notification to the subscribed NFs (254), ensuring that each subscribed NF is updated with the latest information about the change. Upon receiving the notification, the consumer NF 205 can react accordingly to process the event notification (256), such as by making policy adjustments, updating records, or notifying other network functions (e.g., an SMF or UE). This dynamic interaction ensures that the consumer NF 205 is always informed in near real-time about changes or updates occurring within the producer NF 215, enhancing the network's overall responsiveness and adaptability. It should be appreciated that in scenarios where the consumer NF 205 subscribes to the producer NF 215 on behalf of the operator/UE 204, the event notification may be transmitted to the operator/UE 204, not the consumer NF 205.

There are scenarios, however, where the consumer NF 205 is both the originating NF of the event operation and a subscribed NF under the subscription, as shown in FIG. 2. In such cases, sending an event notification (254) to the consumer NF 205 informing it of the event operation it initiated is redundant and inefficient. This redundancy results in unnecessary consumption of signaling bandwidth, as the notification serves no functional purpose for the consumer NF 205, which is already aware of the operation. Additionally, the consumer NF 205 must expend processing resources to receive and handle the notification, further straining network and system efficiency. These wasted resources could have been allocated to more meaningful operations, making such redundant notifications a drain on overall system performance.

Under conventional subscription frameworks, the producer NF 215 is generally not equipped to identify which NF is submitting a communication 246 requesting a change based on an event operation. The 3GPP standards do not provide or define specific guidelines for such activity, leaving it up to the implementation of each NF to manage identity tracking. For instance, when a NF failure occurs, or when SCP mechanisms are used to route communications through alternative paths, the identity of the originating NF that submitted the communication 246 can become obscure to the producer NF 215. Similarly, in scenarios involving PCF instance sets, where multiple PCF instances manage different aspects of network policy, the exact identity of the NF submitting the change request might be unclear. This lack of clarity creates challenges for the producer NF 215 in identifying the originating NF. Consequently, this can lead to inefficiencies or miscommunications when processing the event and notifying the appropriate NFs, such as sending redundant or unnecessary event notifications to the originating NF.

While mechanisms such as OAuth, TLS certificates, or binding headers may be used by the producer NF 215 to determine the identity of the originating NF, these processes can introduce complications, especially during the failure of a primary NF instance within an NF set or service set. In such cases, when a new NF instance takes over, it may send update requests to the producer NF 215, but the subscription information still reflects the details provided by the older, failed NF instance. This mismatch can create significant challenges for the producer NF's logic, as it may not be able to reconcile the incoming update request with the existing subscription. Additionally, the new NF instance might present valid OAuth tokens or TLS certificates, but these credentials are associated with a different instance than the one originally managing the subscription. This discrepancy complicates the producer NF's 215 ability to properly validate and process requests, potentially leading to failures in subscription management, inconsistencies in data handling, or even the rejection of legitimate update operations from the new NF instance.

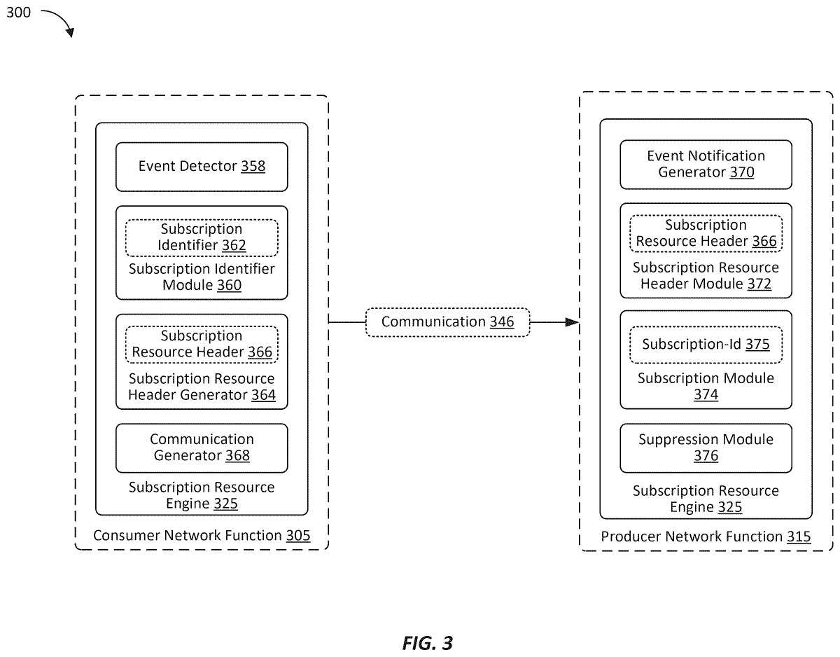

To address at least the above shortcomings of conventional subscription frameworks and clearly identify the originating NF for the producer NF 215, an example subscription resource engine is provided herein. Referring now to FIG. 3, an operational environment 300 including a subscription resource engine 325 is illustrated, according to an embodiment herein. As shown, the subscription resource engine 325 may include a consumer-side and a producer-side. That is, one or more functions of the subscription resource engine 325 may be performed by a consumer NF 305, which may be the same or similar to the consumer NF 205, while one or more functions may be performed by a producer NF 315, which may be the same as the producer NF 215. It should be appreciated, that while the following discussion is focused on the illustrated arrangement of the subscription resource engine 325, in some embodiments, one or more of the illustrated components/functions of the subscription resource engine 325 may be arranged differently. For example, in some embodiments, the subscription resource engine 325 may be hosted separately from the consumer NF 305 and/or the producer NF 315, such as by a third party or another NF.

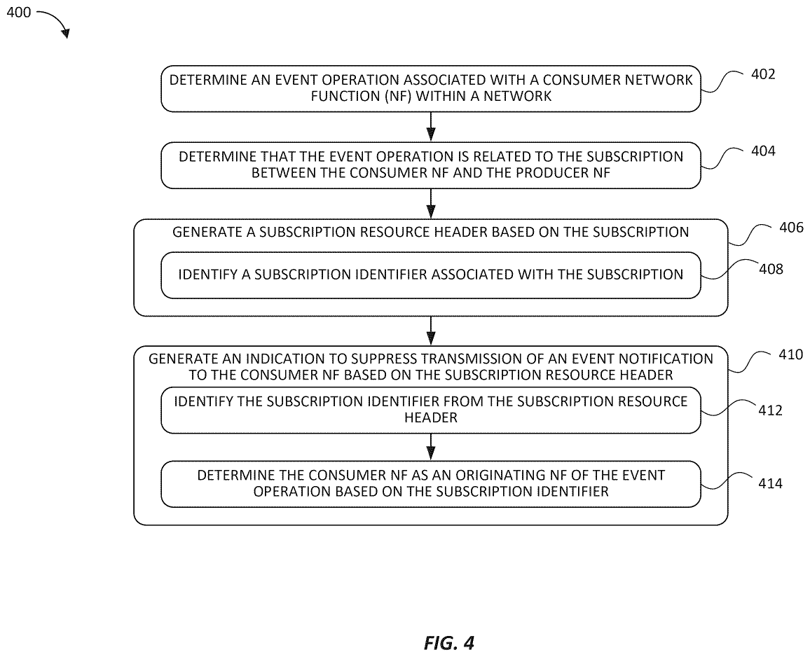

For ease of explanation, FIG. 3 is described in conjunction with FIG. 4, which provides an example subscription resource engine process, in particular a process 400 for providing the subscription resource engine 325 and one or more of its functions, according to an embodiment herein. In other words, FIG. 4 illustrates the process 400 for suppressing transmission of event notifications to an originating NF, according to an embodiment herein. While FIG. 4 is described with relation to FIG. 3, it should be appreciated that components, elements, and steps from any other Figures described herein may be equally applicable.

With reference to FIG. 3, the consumer NF 305 may be subscribed to the producer NF 315, such as to receive event notifications from the producer NF 315 regarding specific resources or objects relevant to the consumer NF 305. That is, the consumer NF 305 may be subscribed to the producer NF 315 under a subscription similar to the subscription 235 described above. For example, the consumer NF 305 may be a PCF, a SMF, an AMF, an NSSF, or an AF, and the producer NF 315 may be a UDR, an NEF, a PCF, a SMF, or an AMF.

At some point during the subscription, the subscription resource engine 325 may determine that an event operation associated with the consumer NF 305 is required or has occurred (402). In particular, the subscription resource engine 325 may include an event detector 358 that detects when an event operation occurs or is required. As those skilled in the art readily appreciate, an event operation refers to a specific action that occurs within a NF, such as a create, delete, or update operation. These operations may involve changes to user data, session information, or network configurations.

Responsive to the event operation, the subscription resource engine 325 may determine that the event operation is related to the subscription established with the producer NF 315 (404). For example, when the event operation occurs, the subscription resource engine 325 may check whether the event is tied to a particular subscription that has been established with the producer NF 315. The subscription generally includes predefined criteria or conditions about which events should trigger communication with the producer NF 315. By looking up the subscription details, the subscription resource engine 325 can determine whether the event operation falls under the scope of the subscription and if it needs to send a request to the producer 315, as described below. In some embodiments, the consumer NF 305 may determine that the event operation is relevant to the subscription with the producer NF 315 and instruct the subscription resource engine 325 to perform one or more of the following functions (e.g., generate a subscription resource header).

If the subscription resource engine 325 determines that the event operation is relevant to the subscription with the producer NF 315, the subscription resource engine 325 may generate a subscription resource header 366 based on the subscription (406). In particular, the subscription resource engine 325 may include a subscription resource header generator 364. The subscription resource header generator 364 may generate the subscription resource header 366 based on the subscription.

To generate the subscription resource header 366, the subscription resource engine 325 may include a subscription identifier module 360 that determines or identifies a respective subscription identifier 362 for the subscription with the producer NF 315 (408). As noted above, upon establishment of the subscription between the consumer NF 305 and the producer NF 315, the producer NF 315 may provide the subscription identifier 362 to the consumer NF 305. The subscription identifier 362 may be or include location information that uniquely identifies the subscription object in its context so that, when provided to the NF producer 315, the NF producer 315 can accurately identify the subscription-Id of the consumer NF 305 as stored in its database. In an example, the subscription identifier 362 is a URI as provided by the producer NF 315 as part of its response to the subscription request submitted by the consumer NF 315 to establish the subscription between the two NFs.

Responsive to identifying the subscription identifier 362, the subscription resource header generator 364 may generate the subscription resource header 366 to include the subscription identifier 362. The subscription resource header 366 may be a custom header that is added to a communication 346 transmitted to the producer NF 315 to inform the producer NF 315 of the event operation or request the producer NF 315 perform an action based on the event operation (e.g., update respective resources). As such, the subscription resource engine 325 may include a communication generator 368 that generates the communication 346 to include information on the event operation and the subscription resource header 366. The communication 346 may include details of the event operation, such as the type of operation performed and the affected data or resource.

In some embodiments, the consumer NF 305 may generate the communication 346 and the subscription resource engine 325 may coordinate with the consumer NF 305 to add the subscription resource header 366 to the communication 346. Responsive to generating the communication 346, the consumer NF 305 may transmit the communication 346 to the producer NF 315. That is, the consumer NF 305 may send the communication 346 to the producer NF 315 via a request message, prompting the producer NF 315 to process the event and take any necessary actions, such as updating stored data or triggering notifications to other subscribed NFs.

On the producer-side, the subscription resource engine 325 may detect the event operation associated with the consumer NF 305. That is, the subscription resource engine 325 on the producer-side may also include an event detector 370 that detects an event operation associated with a subscription. For example, when the communication 346 is received by the producer NF 315, the subscription resource engine 325 may determine whether or not the communication 346 contains an event operation related to a subscription provided by the producer NF 315. If the subscription resource engine 325 determines that the communication 346 contains information on an event operation related to a subscription provided by the producer NF 315, the subscription resource engine 325 may determine if the sending consumer NF 305 is the originating NF of the event operation and if so, generate an indication to suppress transmission of an event notification to the consumer NF 305 (310). Each of these steps are described in turn below.

Upon receiving the communication 346, the subscription resource engine 325 may parse the communication 346 to identify the subscription resource header 366. In particular, the subscription resource engine 325 may include a subscription resource header module 372 that parses the communication 346 to determine whether or not there is a subscription resource header 366. If the communication 346 does not include the subscription resource header 366, then the subscription resource engine 325 may take no further action with respect to the communication 346. In contrast, if the communication 346 contains the subscription resource header 366, the subscription resource header module 372 may identify the subscription identifier 362 from the subscription resource header 366 (412).

The subscription resource engine 325 may include a subscription module 374 in which previously generated subscription-Ids may be stored. As noted above, when a subscription is established between a consumer NF, such as the consumer NF 305, and the producer NF 315, the producer NF 315 may generate and store a subscription-Id that is unique to a respective consumer NF and the subscription. By storing the subscription-Ids for each subscribed NF, a consumer NF can interact with the producer NF 315 to manage and/or cancel a subscription. Here, the subscription module 374 may identify the subscription-Id 375 that is unique to the consumer NF 305 based on the subscription identifier 362 parsed from the subscription resource header 366. Based on the subscription-Id 375, the subscription resource engine 325 may determine that the consumer NF 305 is the originating NF of the event operation (414).

Once the subscription resource engine 325 determines that the consumer NF 305 is the originating NF, the subscription resource engine 325 may cause the producer NF 315 to suppress transmission of the event notification to the consumer NF 305. As described above, under a subscription, when an event operation occurs meeting the criteria of the subscription, the producer NF 315 may generate and send an event notification to subscribed NFs notifying them of the event operation. However, since the consumer NF 305 is the originating NF, the subscription resource engine 325 may coordinate with the producer NF 315 to prevent or otherwise suppress transmission of the event notification to the consumer NF 305, while ensuring transmission of the event notification to the other subscribed NFs under the subscription.

To cause the producer NF 315 to refrain from sending the event notification to the consumer NF 305, the subscription resource engine 325 may include a suppression module 376. The suppression module 376 may identify or list the consumer NF 305 as the originating NF such that when the producer NF 315 transmits the event notifications to subscribed NFs, the producer NF 315 knows to skip transmission to the consumer NF 305. For example, the producer NF 315 may check with the suppression module 376 before sending an event notification to a subscribed NF. If upon the check, the producer NF 315 determines that the subscribed NF is the originating NF, here the consumer NF 305, the producer NF 315 may skip the consumer NF 305 and not send the event notification since it's the originating NF.

In some embodiments, the subscription resource engine 325 executed on the producer NF 315 may store a list of subscription-Ids 375 received within the communication 346. Later, the producer 315 may check with the suppression module 374 based on the list of subscription-Ids 375 to determine whether or not to send a notification to a respective consumer NF 305. If the suppression module 376 of the subscription resource engine 325 determines a consumer NF 305 associated with a respective subscription-Id 375 is listed to receive a notification, the suppression module 376 may remove the consumer NF 305 from notification recipient list. As described in the following operational flows, the producer NF 315, in particular the subscription module 374 may generate and send the notifications to the remaining subscribed consumer NFs.

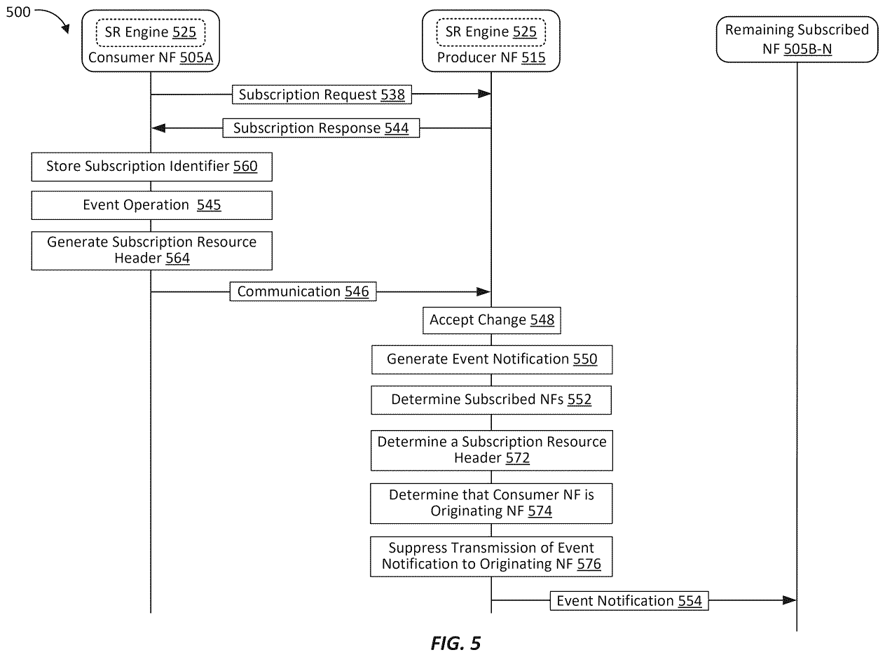

Referring now to FIG. 5, an operational flow 500 for providing one or more functions of a subscription resource engine 525 is illustrated, according to an embodiment herein. As illustrated, a consumer NF 505A, which may be the same or similar to the consumer NF 305, may transmit a subscription request to a producer NF 515 (538), which may be the same or similar to the producer NF 315. Responsive to validating and accepting the subscription request 538, the producer NF 515 may return a subscription response to the consumer NF 505A (544). As noted above, the subscription response may include a subscription identifier that is unique to the consumer NF 505A and the established subscription between the consumer NF 505A and the producer NF 515. Responsive to receiving the subscription response, the subscription response (SR) engine 525 on the consumer-side may parse the subscription response to identify the subscription identifier. Once identified, the consumer-side SR engine 525 may store the subscription identifier (560) and associate the subscription identifier with the subscription with the producer NF 515.

At a subsequent time, an event operation may occur (545) at or in relation to the consumer NF 505A. Responsive to the event operation, the consumer-side SR engine 525 may generate a subscription resource header (564) as described above. Specifically, the consumer-side SR engine 525 may determine that the event operation is related to the subscription with the producer NF 515 and identify the respective subscription identifier. Then, the consumer-side SR engine 525 may generate the subscription resource header to include the subscription identifier. The subscription resource header may be included as part of a communication that is transmitted to the producer NF 515 (546). The communication may include information on the event operation and may include a request to the producer NF 515 to perform one or more actions based on the event operation.

On the producer-side, responsive to receiving the communication, the producer NF 515 may accept and perform any requested actions based on the communication (548). As noted above, since the event operation is relevant to the subscription, it may trigger the producer NF 515 to generate an event notification (550). The producer NF 515 may determine one or more subscribed NFs to which the event notification should be transmitted under the subscription (552). In the illustrated example, the subscribed NFs may include NFs 505A-N.

Simultaneously or sequentially to the producer NF 515 generating the event notification and/or identifying which NFs are subscribers under the respective subscription, the producer-side SR engine 525 may determine that the communication includes a subscription resource header (572). Then the producer-side SR engine 525 may determine that the consumer NF 505A is the originating NF (574). For example, the producer-side SR engine 525 may parse the subscription resource header to identify the subscription identifier. Then based on the subscription identifier, the SR engine 525 may look-up a corresponding subscription-Id and determine that the subscription-Id is associated with the consumer NF 505A. Based on this, the producer-side SR engine 525 may determine that the consumer NF is the originating NF.

The producer-side SR engine 525 may then suppress transmission of the event notification for the event operation to the consumer NF 505A (576). As described above, this may include generating an indication to suppress transmission of the event notification to the consumer NF 505A. Based on the indication, the producer NF 515 may skip the consumer NF 505A during the sending process of the event notification. Instead, the producer NF 515 may send the event notification to the remaining subscribed NFs 505B-N (554). As can be appreciated, the remaining subscribed NFs 505B-N may be other consumer NFs that are subscribed to the producer NF 515 and there may be any number of remaining subscribed NFs 505B-N.

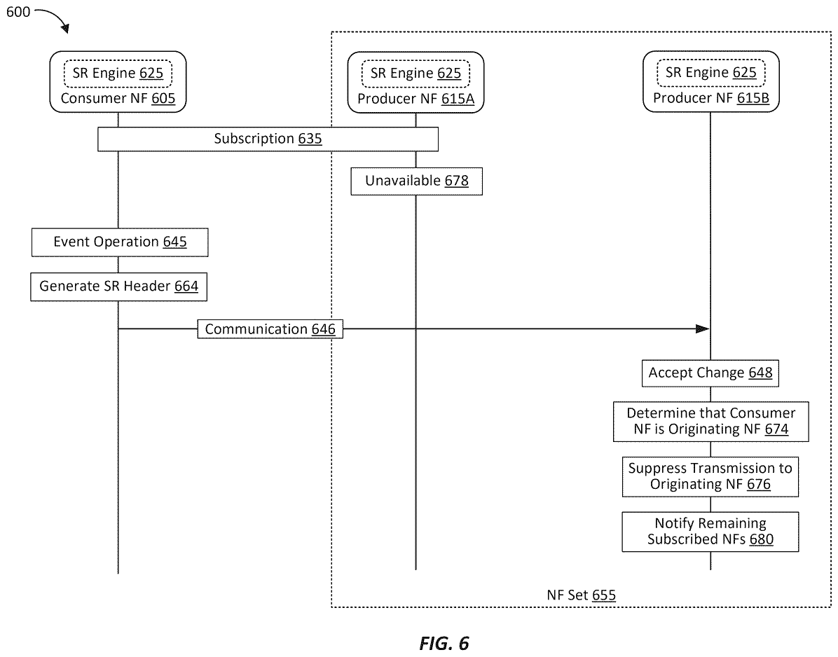

Referring now to FIG. 6, an operational flow 600 illustrating a subscription resource engine 625 operating as part of a NF set on the producer-side is provided, according to an embodiment herein. As illustrated, a consumer NF 605, which may be the same or similar to the consumer NF 305, may be subscribed to a producer NF 615A, which may be the same or similar to the producer NF 315A (635). At a point after the subscription is established, the producer NF 615A may become unavailable (678). For example, the producer NF 615A may experience operational issues such as system failures or planned maintenance activities. Additionally, network connectivity problems may disrupt communication between the producer NF 615A and the network. Hardware malfunctions or degradation in the physical infrastructure supporting the NF 615A could also lead to unavailability. Software issues, including bugs or crashes, may impact the producer NF's 615A functionality. Overload conditions, where the NF is unable to handle excessive traffic or resource demands, may further contribute to its unavailability.

On the consumer-side, an event operation may occur (645). The event operation may trigger the consumer NF 605 to notify the producer NF 615A of the event operation and, at times, request the producer NF 615A perform one or more actions based on the event operation. As such, the consumer-side SR engine 625, which may be the same or similar to the SR engine 325, may generate a subscription resource header (664) based on the subscription with the producer NF 615A.

A communication containing the event operation information and the subscription resource header may be transmitted from the consumer NF 605 to the producer NF 615A. However, if the producer NF 615A is unavailable, the communication can be rerouted to another producer NF, such as producer NF 615B, in accordance with standard 3GPP routing protocols (646). As illustrated, producer NFs 615A and 615B belong to an NF set 655. In this context, the NF set 655 refers to a group of functionally equivalent NFs that can handle the same tasks and share state information. Consequently, the producer NF 615B has access to all the necessary data related to the subscription between the consumer NF 605 and the originally designated producer NF 615A.

Accordingly, when the producer NF 615B receives the communication, it may accept the change and perform any necessary actions (648) based on the event operation. Then, the producer NF 615B may determine that the accepted change requires notifying subscribed NFs under a respective subscription. As such, the producer NF 615B may generate an event notification based on the event operation to inform subscribing NFs of the change.

To prevent the producer NF 615B from sending the event notification to the consumer NF 605, a producer-side SR engine 625 may determine that the consumer NF 605 is the originating NF (674). As described above, this may include parsing the communication to identify the subscription resource header and determining the consumer NF 605 based on the header. Since the producer NF 615B is part of the NF set 655, the producer 615B may readily identify the subscription-Id for the consumer NF 605. Based on the consumer NF 605 being the originating NF, the producer-side SR engine 625 may generate an indication to suppress transmission of the event notification to the consumer NF 605 (676). Based on this indication, the producer NF 615B may notify the remining subscribed NFs (680) of the event operation, while skipping the consumer NF 605.

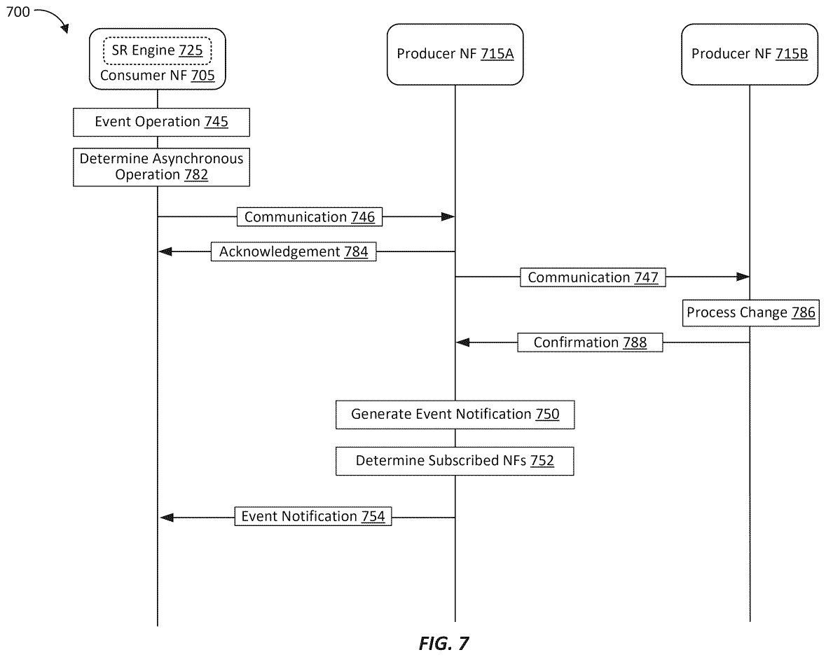

Referring now to FIG. 7, an operational flow 700 illustrating an embodiment in which a subscription resource (SR) engine 725 may refrain from suppressing transmission of an event notification to an originating NF is provided, according to an embodiment herein. There may be scenarios in which an originating NF, such as a consumer NF 705, receiving an event notification is appropriate and, at times required. Once such scenario involves asynchronous completion of an event operation, such as illustrated by the flow 700. As will be described in greater detail below, an asynchronous completion of an event operation may involve scenarios in which a producer NF, such as the producer NF 715A initiates an action or operation but does not wait for its completion before moving onto another task.

As illustrated, an event operation may occur with respect to the consumer NF 705, which may be the same or similar to the consumer NF 705 (745). The consumer NF 705 may be subscribed to a producer NF 715A. As such, responsive to the event operation, a consumer-side SR engine 725 may analyze the event operation to determine whether or not to generate a subscription resource header based on the event operation. In the illustrated flow 700, the SR engine 715 may determine that the event operation involves an asynchronous operation (782). For example, the SR engine 725 may determine that a respective action required by the producer NF 715A is an asynchronous action. In some embodiments, this determination may be predefined based on a code implementation, operator configuration, or policy rules that define the consumer NF's 705 behavior, such as whether to perform synchronous or asynchronous actions with the producer NF 715A.

Based on the event operation involving an asynchronous operation, the consumer-side SR engine 725 may refrain from generating a subscription resource header. The SR engine 725 may refrain from generating and/or including the subscription resource header in the communication transmitted to the producer 715A (746) because the consumer NF 705 requests or requires notification of when the requested action in the communication is completed. That is, because a requested action within the communication may be performed asynchronously by the producer NF 715A, the consumer NF 705 may want to be notified when the action is completed, and thus may want to receive the event notification. The event notification may serve as an indication that the requested action is completed in the asynchronous operation.

As illustrated, the consumer NF 705 may transmit the communication containing the event operation information to the producer NF 715A (746). The producer NF 715A may return an acknowledgement that the communication was received to the consumer NF 705 (784). Simultaneously or sequentially, the producer NF 715A may begin performing the action requested in the communication, which may include requesting another NF, such as a producer NF 715B perform one or more actions. Here, the producer NF 715A may transmit a communication to the producer NF 715B requesting it process a change associated with the event operation (747). Responsive to receiving the request, the producer NF 715B may process the change (786) and return a confirmation of its completion to the producer NF 715A (788).

When the producer NF 715A receives the confirmation that the change is completed, the producer NF 715A may generate event notifications under the subscription (750) and determine which NFs to notify by the event notification (e.g., the subscribed NFs) (752). Since the initial communication (746) did not include a subscription resource header, the producer NF 715A may transmit the event notification to the consumer NF 705 (754). The consumer NF 705 may process the event notification as confirmation that the requested action/change is completed for the event operation.

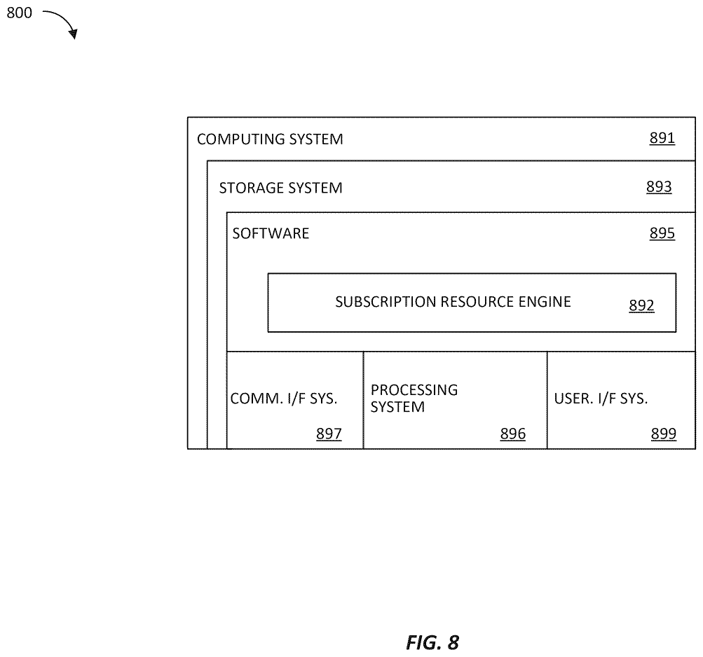

Referring now to FIG. 8, is a diagram of a system 800 configured to implement a subscription resource engine, according to an embodiment herein. The system 800 may be an example of an apparatus including a computing apparatus 891 that is representative of any system or collection of systems in which the various processes, systems, programs, services, and scenarios disclosed herein may be implemented. For example, computing apparatus 891 may be an example subscription resource engine, such as the subscription resource engine 325/525/625/725, a producer NF or consumer NF, such as any of the consumer NFs or home producer NFs discussed herein, or any of the subcomponents depicted in the 5G network, 100, operational flows 400, 500 600, or 700, or the operational environment 300 of FIG. 3, respectively. Examples of computing apparatus 891 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 891 may be implemented as a single apparatus, system, or device or may be implemented in a distributed manner as multiple apparatuses, systems, or devices. Computing apparatus 891 may include, but is not limited to, processing system 896, storage system 893, software 895, communication interface system 897, and user interface system 899. Processing system 896 may be operatively coupled with storage system 893, communication interface system 897, and user interface system 899.

Processing system 896 may load and execute software 895 from storage system 893. Software 895 may include a subscription resource engine 892, which may be representative of any of the operations for providing a subscription resource engine or any of its related functions, as discussed with respect to the preceding figures. When executed by processing system 896, software 895 may direct processing system 896 to operate as described herein for at least the various processes, such as the process 400 or any of the operational flows 500-700, operational scenarios, and sequences discussed in the foregoing implementations. Computing apparatus 891 may optionally include additional devices, features, or functionality not discussed for purposes of brevity.

In some embodiments, processing system 896 may comprise a micro-processor and other circuitry that retrieves and executes software 895 from storage system 893. Processing system 896 may be implemented within a single processing device but may also be distributed across multiple processing devices or sub-systems that cooperate in executing program instructions. Examples of processing system 896 may include general purpose central processing units, graphical processing units, application specific processors, and logic devices, as well as any other type of processing device, combinations, or variations thereof.

Storage system 893 may comprise any memory device or computer-readable storage medium readable by processing system 896 and capable of storing software 895. Storage system 893 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage medium a propagated signal.

In addition to computer-readable storage medium, in some implementations storage system 893 may also include computer readable communication media over which at least some of software 895 may be communicated internally or externally. Storage system 893 may be implemented as a single storage device but may also be implemented across multiple storage devices or sub-systems co-located or distributed relative to each other. Storage system 893 may comprise additional elements, such as a controller, capable of communicating with processing system 896 or possibly other systems.

Software 895 (including the subscription resource engine 892 among other functions) may be implemented in program instructions that may, when executed by processing system 896, direct processing system 896 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 895 may include additional processes, programs, or components, such as operating system software, virtualization software, or other application software. Software 895 may also comprise firmware or some other form of machine-readable processing instructions executable by processing system 896.

In general, software 895 may, when loaded into processing system 896 and executed, transform a suitable apparatus, system, or device (of which computing apparatus 891 is representative) overall from a general-purpose computing system into a special-purpose computing system as described herein. Indeed, encoding software 895 on storage system 893 may transform the physical structure of storage system 893. The specific transformation of the physical structure may depend on various factors in different implementations of this description. Examples of such factors may include, but are not limited to, the technology used to implement the storage media of storage system 893 and whether the computer-storage media are characterized as primary or secondary storage, as well as other factors.

For example, if the computer-readable storage medium is implemented as semiconductor-based memory, software 895 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 897 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 891 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

The foregoing examples and descriptions are described herein in the context of systems and methods for providing a subscription resource engine or one or more of its related functions. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium; processor-executable instructions stored on the computer-readable storage medium; and one or more processors coupled to the computer-readable storage medium and configured to execute the processor-executable instructions to operate a producer network function (NF) within a network, wherein the producer NF comprises a subscription resource engine, such that the processor-executable instructions, when executed by the one or more processors, direct the computing apparatus, to at least: detect, by the subscription resource engine, an event operation associated with a first consumer NF within the network, wherein: the first consumer NF is subscribed to the producer NF; and the subscription allows the first consumer NF to receive event notifications from the producer NF regarding specific resources or objects relevant to the first consumer NF; generate, by the subscription resource engine, the event notification based on the event operation; determine, by the subscription resource, a subscription resource header associated with the event operation; determine, by the subscription resource engine, that the first consumer NF is an originating NF for the event operation; and suppress, by the subscription resource engine, transmission of the event notification to the first consumer NF.

Example 2 is the computing apparatus of any previous or subsequent Example, wherein the processor-executable instructions to determine, by the subscription resource engine, that the first consumer NF is the originating NF of the event operation, when executed by the one or more processors, further direct the computing apparatus to: identify, by the subscription resource engine, a subscription identifier from the subscription resource header; and determine, by the subscription resource engine, that the subscription identifier corresponds to the first consumer NF.

Example 3 is the computing apparatus of any previous or subsequent Example, wherein the processor-executable instructions, when executed by the one or more processors, further direct the computing apparatus to: transmit, by the producer NF, the event notification to one or more other consumer NFs subscribed to the producer NF.

Example 4 is the computing apparatus of any previous or subsequent Example, wherein: the processor-executable instructions to detect, by the subscription resource engine, the event operation associated with the first consumer NF, when executed by the one or more processors, further direct the computing apparatus to: receive, by the producer NF, a communication from the first consumer NF, wherein the communication comprises the event operation and the subscription resource header; and the processor-executable instructions to determine, by the subscription resource engine, the subscription resource header associated with the event operation, when executed by the one or more processors, further direct the computing apparatus to: parse, by the subscription resource engine, the communication to identify the subscription resource header.

Example 5 is the computing apparatus of any previous or subsequent Example, wherein the processor-executable instructions, when executed by the one or more processors, further direct the computing apparatus to: receive, by the producer NF, a subscription request from a second consumer NF, wherein the subscription request is for the first consumer NF to subscribe to the producer NF; determine, by the subscription resource engine, that the producer NF accepts the subscription request; generate, by the subscription resource engine, a subscription identifier for the first consumer NF; and associate, by the subscription resource engine, the subscription identifier with the first consumer NF.

Example 6 is the computing apparatus of any previous or subsequent Example, wherein the processor-executable instructions to suppress, by the subscription resource engine, transmission of the event notification to the first consumer NF, when executed by the one or more processors, further direct the computing apparatus to: determine, by the producer NF, a plurality of consumer NFs subscribed to the producer NF, wherein the plurality of consumer NFs comprise the first consumer NF; skip, by the producer NF, transmission of the event notification to the first consumer NF; and transmit, by the producer NF, the event notification to one or more remaining consumer NFs in the plurality of consumer NFs.

Example 7 is the computing apparatus of any previous or subsequent Example, wherein: the processor-executable instructions, when executed by the one or more processors, further direct the computing apparatus to: receive, by the producer NF, a subscription request from the first consumer NF; and generate, by the subscription resource engine, a subscription identifier for the first consumer NF responsive to the producer NF accepting the subscription request; and the processor-executable instructions to determine, by the subscription resource engine, that the first consumer NF is the originating NF of the event operation, when executed by the one or more processors, further direct the computing apparatus to: determine, by the producer NF, that the first consumer NF is the originating NF of the event operation based on subscription resource header comprising the subscription identifier.

Example 8 is a method comprising: detecting, by a subscription resource engine, an event operation associated with a first consumer NF within a network, wherein: the first consumer NF is subscribed to a producer NF within a network; and the subscription allows the first consumer NF to receive event notifications from the producer NF regarding specific resources or objects relevant to the first consumer NF; determining, by the subscription resource engine, that the event operation is related to the subscription between the first consumer NF and the producer NF; generating, by the subscription resource engine, a subscription resource header based on the subscription; and generating, by the subscription resource engine, an indication to suppress transmission of an event notification associated with the event operation to the first consumer NF based on the subscription resource header, wherein the indication to suppress transmission of the event notification causes the producer NF to skip transmission of the event notification to the first Consumer NF.

Example 9 is the method of any previous or subsequent Example, wherein generating, by the subscription resource engine, the indication to suppress transmission of the event notification to the first consumer NF based on the subscription resource header comprises: identifying, by the subscription resource engine, a subscription identifier from the subscription resource header; and determining, by the subscription resource engine, the first consumer NF is an originating NF of the event operation based on the subscription identifier; and generating, by the subscription resource engine, the indication to suppress transmission of the event notification to the first consumer NF based on the first consumer NF being the originating NF of the event operation.

Example 10 is the method of any previous or subsequent Example, wherein the method further comprises: generating, by the producer NF, the event notification based on the event operation; determining, by the producer NF, a plurality of consumer NFs subscribed to the producer NF; and transmitting, by the producer NF, the event notification to the plurality of consumer NFs.

Example 11 is the method of any previous or subsequent Example, wherein the method further comprises: receiving, by the producer NF, a subscription request from a second consumer NF, wherein the subscription request is for the first consumer NF to subscribe to the producer NF; generating, by the producer NF, a subscription identifier for the first consumer NF responsive to accepting the subscription request; and transmitting, by the producer NF, the subscription identifier to the first consumer NF.

Example 12 is the method of any previous or subsequent Example, wherein generating, by the subscription resource engine, the subscription resource header based on the subscription comprises: determining, by the subscription resource engine, a subscription identifier associated with the subscription with the producer NF; and generating, by the subscription resource engine, the subscription resource header to include the subscription identifier.

Example 13 is the method of any previous or subsequent Example, wherein the method further comprises: transmitting, by the first consumer NF, a communication comprising the event operation and subscription resource header to the producer NF.

Example 14 is the method of any previous or subsequent Example, wherein the network comprising the first consumer NF and the producer NF is a 5G network.

Example 15 is the method of any previous or subsequent Example, wherein: the producer NF is part of an instance set comprising a plurality of producer NFs; and the indication to suppress transmission of the event notification to the first consumer NF causes each of the plurality of producer NFs to skip transmission of the event notification to the first consumer NF.

Example 16 is a computer-readable storage medium comprising processor-executable instructions, wherein the processor-executable instructions, in part, operate a first network function (NF) within a first network such to cause one or more processors to: determine, by a consumer network function (NF), an event operation, wherein: the consumer NF is subscribed to a producer NF within a network; the subscription allows the consumer NF to receive event notifications from the producer NF regarding specific resources or objects relevant to the consumer NF; and the consumer NF comprises a subscription resource engine; generate, by the subscription resource engine, a subscription resource header based on the subscription; and transmit, by the subscription resource engine, a communication comprising the event operation and subscription resource header to the producer NF, wherein the subscription resource header causes the producer NF to suppress an event notification for the event operation being sent to the consumer NF.

Example 17 is the computer-readable storage medium of any previous or subsequent Example, wherein the processor-executable instructions to generate, by the subscription resource engine, the subscription header based on the subscription cause the one or more processors to further execute processor-executable instructions stored in the computer-readable storage medium to: determine, by the subscription resource engine, a subscription identifier for the subscription with the producer NF; and generate, by the subscription resource engine, the subscription resource header to include the subscription identifier.

Example 18 is the computer-readable storage medium of any previous or subsequent Example, wherein the processor-executable instructions cause the one or more processors to further execute processor-executable instructions stored in the computer-readable storage medium to: transmit, by the consumer NF, a subscription request to the producer NF, wherein the subscription request is for the consumer NF to subscribe to the producer NF; receive, by the consumer NF, a subscription response from the producer NF, wherein the subscription response comprises a subscription identifier unique to the consumer NF and the subscription; and parse, by the subscription resource engine, the subscription response to identify the subscription identifier; and store, by the subscription resource engine, the subscription identifier as associated with the subscription with the producer NF.

Example 19 is the computer-readable storage medium of any previous or subsequent Example, wherein the processor-executable instructions to generate, by the subscription resource engine, the subscription resource header based on the subscription cause the one or more processors to further execute processor-executable instructions stored in the computer-readable storage medium to: determine, by the subscription resource engine, that the event operation is related to the subscription between the consumer NF and the producer NF; and generate, by the subscription resource engine, the resource header based on the event operation being related to the subscription.

Example 20 is the computer-readable storage medium of any previous or subsequent Example, wherein the event operation comprises at least one of: a create operation for a resource or object associated with the consumer NF; an update operation for a resource or object associated with the consumer NF; or a delete operation for a resource or object associated with the consumer NF.

What is claimed is:

1. A computing apparatus comprising:
a computer-readable storage medium;
processor-executable instructions stored on the computer-readable storage medium; and
one or more processors coupled to the computer-readable storage medium and configured to execute the processor-executable instructions to operate a producer network function (NF) within a network, wherein the producer NF comprises a subscription resource engine, such that the processor-executable instructions, when executed by the one or more processors, direct the computing apparatus, to at least:
detect, by the subscription resource engine, an event operation associated with a first consumer NF within the network, wherein:
the first consumer NF is subscribed to the producer NF; and
the subscription allows the first consumer NF to receive event notifications from the producer NF regarding specific resources or objects relevant to the first consumer NF;
generate, by the subscription resource engine, the event notification based on the event operation;
determine, by the subscription resource engine, that the first consumer NF is an originating NF for the event operation; and
suppress, by the subscription resource engine, transmission of the event notification to the first consumer NF.

2. The computing apparatus of claim 1, wherein the processor-executable instructions to determine, by the subscription resource engine, that the first consumer NF is the originating NF of the event operation, when executed by the one or more processors, further direct the computing apparatus to:
determine, by the subscription resource, a subscription resource header associated with the event operation;
identify, by the subscription resource engine, a subscription identifier from the subscription resource header; and
determine, by the subscription resource engine, that the subscription identifier corresponds to the first consumer NF.

3. The computing apparatus of claim 1, wherein the processor-executable instructions, when executed by the one or more processors, further direct the computing apparatus to:
transmit, by the producer NF, the event notification to one or more other consumer NFs subscribed to the producer NF.

4. The computing apparatus of claim 1, wherein the processor-executable instructions to detect, by the subscription resource engine, the event operation associated with the first consumer NF, when executed by the one or more processors, further direct the computing apparatus to:
receive, by the producer NF, a communication from the first consumer NF, wherein the communication comprises the event operation and a subscription resource header; and
parse, by the subscription resource engine, the communication to identify the subscription resource header.

5. The computing apparatus of claim 1, wherein the processor-executable instructions, when executed by the one or more processors, further direct the computing apparatus to:
receive, by the producer NF, a subscription request from a second consumer NF, wherein the subscription request is for the first consumer NF to subscribe to the producer NF;
determine, by the subscription resource engine, that the producer NF accepts the subscription request;
generate, by the subscription resource engine, a subscription identifier for the first consumer NF; and
associate, by the subscription resource engine, the subscription identifier with the first consumer NF.

6. The computing apparatus of claim 1, wherein the processor-executable instructions to suppress, by the subscription resource engine, transmission of the event notification to the first consumer NF, when executed by the one or more processors, further direct the computing apparatus to:
determine, by the producer NF, a plurality of consumer NFs subscribed to the producer NF, wherein the plurality of consumer NFs comprise the first consumer NF;
skip, by the producer NF, transmission of the event notification to the first consumer NF; and
transmit, by the producer NF, the event notification to one or more remaining consumer NFs in the plurality of consumer NFs.

7. The computing apparatus of claim 1, wherein:
the processor-executable instructions, when executed by the one or more processors, further direct the computing apparatus to:
receive, by the producer NF, a subscription request from the first consumer NF; and
generate, by the subscription resource engine, a subscription identifier for the first consumer NF responsive to the producer NF accepting the subscription request; and
the processor-executable instructions to determine, by the subscription resource engine, that the first consumer NF is the originating NF of the event operation, when executed by the one or more processors, further direct the computing apparatus to:
determine, by the producer NF, that the first consumer NF is the originating NF of the event operation based on a subscription resource header comprising the subscription identifier.

8. A method comprising:
detecting, by a subscription resource engine, an event operation associated with a first consumer NF within a network, wherein:
the first consumer NF is subscribed to a producer NF within the network; and
the subscription allows the first consumer NF to receive event notifications from the producer NF regarding specific resources or objects relevant to the first consumer NF;
determining, by the subscription resource engine, that the event operation is related to the subscription between the first consumer NF and the producer NF;
generating, by the subscription resource engine, a subscription resource header based on the subscription; and
generating, by the subscription resource engine, an indication to suppress transmission of an event notification associated with the event operation to the first consumer NF based on the subscription resource header, wherein the indication to suppress transmission of the event notification causes the producer NF to skip transmission of the event notification to the first consumer NF.

9. The method of claim 8, wherein generating, by the subscription resource engine, the indication to suppress transmission of the event notification to the first consumer NF based on the subscription resource header comprises:
identifying, by the subscription resource engine, a subscription identifier from the subscription resource header; and
determining, by the subscription resource engine, the first consumer NF is an originating NF of the event operation based on the subscription identifier; and
generating, by the subscription resource engine, the indication to suppress transmission of the event notification to the first consumer NF based on the first consumer NF being the originating NF of the event operation.

10. The method of claim 8, wherein the method further comprises:
generating, by the producer NF, the event notification based on the event operation;
determining, by the producer NF, a plurality of consumer NFs subscribed to the producer NF; and
transmitting, by the producer NF, the event notification to the plurality of consumer NFs.

11. The method of claim 8, wherein the method further comprises:
receiving, by the producer NF, a subscription request from a second consumer NF, wherein the subscription request is for the first consumer NF to subscribe to the producer NF;
generating, by the producer NF, a subscription identifier for the first consumer NF responsive to accepting the subscription request; and
transmitting, by the producer NF, the subscription identifier to the first consumer NF.

12. The method of claim 8, wherein generating, by the subscription resource engine, the subscription resource header based on the subscription comprises:
determining, by the subscription resource engine, a subscription identifier associated with the subscription with the producer NF; and
generating, by the subscription resource engine, the subscription resource header to include the subscription identifier.

13. The method of claim 8, wherein the method further comprises:
transmitting, by the first consumer NF, a communication comprising the event operation and subscription resource header to the producer NF.

14. The method of claim 8, wherein the network comprising the first consumer NF and the producer NF is a 5G network.

15. The method of claim 8, wherein:
the producer NF is part of an instance set comprising a plurality of producer NFs; and
the indication to suppress transmission of the event notification to the first consumer NF causes each of the plurality of producer NFs to skip transmission of the event notification to the first consumer NF.

16. A computer-readable storage medium comprising processor-executable instructions, wherein the processor-executable instructions, in part, operate a first network function (NF) within a first network such to cause one or more processors to:
determine, by a consumer network function (NF), an event operation, wherein:
the consumer NF is subscribed to a producer NF within a network;
the subscription allows the consumer NF to receive event notifications from the producer NF regarding specific resources or objects relevant to the consumer NF; and
the consumer NF comprises a subscription resource engine;
generate, by the subscription resource engine, a subscription resource header based on the subscription; and
transmit, by the subscription resource engine, a communication comprising the event operation and subscription resource header to the producer NF, wherein the subscription resource header causes the producer NF to suppress an event notification for the event operation being sent to the consumer NF.

17. The computer-readable storage medium of claim 16, wherein the processor-executable instructions to generate, by the subscription resource engine, the subscription header based on the subscription cause the one or more processors to further execute processor-executable instructions stored in the computer-readable storage medium to:
determine, by the subscription resource engine, a subscription identifier for the subscription with the producer NF; and
generate, by the subscription resource engine, the subscription resource header to include the subscription identifier.

18. The computer-readable storage medium of claim 16, wherein the processor-executable instructions cause the one or more processors to further execute processor-executable instructions stored in the computer-readable storage medium to:
transmit, by the consumer NF, a subscription request to the producer NF, wherein the subscription request is for the consumer NF to subscribe to the producer NF;
receive, by the consumer NF, a subscription response from the producer NF, wherein the subscription response comprises a subscription identifier unique to the consumer NF and the subscription; and
parse, by the subscription resource engine, the subscription response to identify the subscription identifier; and
store, by the subscription resource engine, the subscription identifier as associated with the subscription with the producer NF.

19. The computer-readable storage medium of claim 16, wherein the processor-executable instructions to generate, by the subscription resource engine, the subscription resource header based on the subscription cause the one or more processors to further execute processor-executable instructions stored in the computer-readable storage medium to:
determine, by the subscription resource engine, that the event operation is related to the subscription between the consumer NF and the producer NF; and
generate, by the subscription resource engine, the resource header based on the event operation being related to the subscription.

20. The computer-readable storage medium of claim 16, wherein the event operation comprises at least one of:
a create operation for a resource or object associated with the consumer NF;
an update operation for a resource or object associated with the consumer NF; or
a delete operation for a resource or object associated with the consumer NF.
